(19) United States
(12) Patent Application Publication
(10) Pub. No.: US 2026/0097570 A1
(43) Pub. Date: Apr. 9, 2026

(54) Multi-Roll Calender for Processing Active Material Onto a Coating Carrier and Method Thereof

(71) Applicant: Matthews International GmbH, Vreden (DE)

(72) Inventor: Rene WOLTERS, Vreden (DE)

(21) Appl. No.: 19/350,239

(22) Filed: Oct. 6, 2025

(30) Foreign Application Priority Data
Oct. 8, 2024 (DE) 10 2024 129 030.7

(51) Int. Cl. B30B 3/04; B30B 7/00

(52) U.S. Cl. CPC B30B 3/04; B30B 7/00

(57) ABSTRACT

The present disclosure provides a multi-roll calender configured to processing material onto a coating. In particular, the present disclosure provides a multi-roll calender and method with a first roll and a second roll configured to form a first nip, wherein the first roll and the second roll laminate a first film on a first side of a foil in the first nip. The system and method may comprise a third roll and a fourth roll configured to form a second nip between the third roll and the fourth roll, wherein the third roll and the fourth roll laminate a second film on a second side of the foil in the second nip.

### BACKGROUND

### Cross-Reference to Related Applications

The present application claims priority to German Patent Application No. 10 2024 129 030.7, filed Oct. 8, 2024, which is incorporated herein by reference in its entirety.

### Technical Field

The present disclosure relates generally to the field of calendering equipment, and more particularly, to systems and methods for calendering a film onto a carrier material.

### Technical Description

Calendering equipment is often used for processing material into film as well as coating carrier with material and/or film. For example, calendering equipment can be used to manufacture energy storage devices, which are used to power electric, electromechanical, electrochemical, or other devices. Producing energy storage devices requires laminating a coating carrier with a material.

### SUMMARY

The present disclosure provides a multi-roll calender and method configured to processing material onto a coating. In particular, the present disclosure provides a multi-roll calender and method with a first roll and a second roll configured to form a first nip, wherein the first roll and the second roll laminate a first film on a first side of a foil in the first nip. The system and method may comprise a third roll and a fourth roll configured to form a second nip between the third roll and the fourth roll, wherein the third roll and the fourth roll laminate a second film on a second side of the foil in the second nip.

In some embodiments, the third roll in combination with the second roll is configured to form a gap.

In some embodiments, the gap is between 0 and 30 cm.

In some embodiments, the system and method may further comprise a fifth roll next to the first roll and a sixth roll configured to form a third nip in combination with the fifth roll, wherein the fifth roll and sixth roll are configured to receive powder and form the first film from the powder.

In some embodiments, the system and method may further comprise a seventh roll next to the first roll; and an eighth roll configured to form a fourth nip in combination with the seventh roll, wherein the seventh roll and the eighth roll are configured to receive powder and form the second film from the powder.

In some embodiments, the system and method may further comprise an idle roll configured to allow the film to contact more surface of the second roll.

In some embodiments, the idle roll is smaller in diameter than the second roll.

In some embodiments, the idle roll is heated.

In some embodiments, the first roll, the second roll, the third roll, and the fourth roll have the same diameter.

In some embodiments, all the rolls are horizontally collinear.

In some embodiments, all the rolls are supported on a common frame structure.

In some embodiments, the first roll is heated.

In some embodiments, the idle roller puts more of the circumference of the heated first roll in contact with the foil.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. Hence, specific dimensions and other physical characteristics related to the embodiments disclosed herein are not to be considered as limiting. Further, it is to be understood that the disclosure may assume various alternative variations and step sequences, except where expressly specified to the contrary.

### BRIEF DESCRIPTION OF THE DRAWINGS

Additional advantages and details of non-limiting embodiments or aspects are explained in greater detail below with reference to the exemplary embodiments that are illustrated in the accompanying schematic figures, in which:

FIG. 1 is a diagram of a multi-roll calender system;

FIG. 2 is a close up view of a multi-roll calender system depicting lamination of film onto a first side of foil;

FIG. 3 is a close up view of a multi-roll calender system depicting a gap between rolls;

FIG. 4 is a close up view of a multi-roll calender system depicting lamination of film onto a second side of foil;

FIG. 5 is a diagram of a multi-roll calender system with no gap;

FIG. 6 is a diagram of a multi-roll calender system with two material delivery systems;

FIG. 7 is a diagram of a multi-roll calender system with an idle roll; and

FIG. 8 is a close up view of a multi-roll calender system depicting an idle roll.

FIG. 9 is a diagram of a multi-roll calender system that laminated two layers of film on the same side of the foil.

FIG. 10 is a diagram of a multi-roll calender system that laminated two layers of film on the same side of the foil and another layer film on the opposite side of the foil.

FIG. 11 is a flow chart of an example method of laminating material onto a coating carrier using a multi-roll system

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer-readable medium and executed by a computer or processor, whether such computer or processor is explicitly shown. While each of the figures illustrates a particular embodiment for purposes of illustrating a clear example, other embodiments may omit, add to, reorder, and/or modify any of the elements shown in the figures. Further, when practical, similar reference numbers denote similar structures, features, or elements.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary.

All numbers and ranges used in the specification and claims are to be understood as being modified in all instances by the term “about”. The term “about” means plus or minus 25% of the stated value, such as plus or minus 10% of the stated value. However, this should not be considered as limiting to any analysis of the values under the doctrine of equivalents.

Unless otherwise indicated, all ranges or ratios disclosed herein are to be understood to encompass the beginning and ending values and any and all subranges or subratios subsumed therein. For example, a stated range or ratio of “1 to 10” should be considered to include any and all subranges or subratios between (and inclusive of) the minimum value of 1 and the maximum value of 10; that is, all subranges or subratios beginning with a minimum value of 1 or more and ending with a maximum value of 10 or less. The ranges and/or ratios disclosed herein represent the average values over the specified range and/or ratio.

The terms “first,” “second,” and the like are not intended to refer to any particular order or chronology, but refer to different conditions, properties, or elements.

The term “at least” is synonymous with “greater than or equal to”.

The terms “comprises,” “comprising,” or any other variations thereof, are intended to cover a non-exclusive inclusion, such that a setup, device, or method that comprises a list of components or steps does not include only those components or steps but may include other components or steps not expressly listed or inherent to such setup, device, or method. In other words, one or more elements in a system or apparatus proceeded by “comprises . . . a” does not, without more constraints, preclude the existence of other elements or additional elements in the system or method.

The terms “includes,” “including,” or any other variations thereof are intended to cover a non-exclusive inclusion such that a setup, device, or method that includes a list of components or steps does not include only those components or steps but may include other components or steps not expressly listed or inherent to such setup, device, or method. In other words, one or more elements in a system or apparatus proceeded by “includes . . . a” does not, without more constraints, preclude the existence of other elements or additional elements in the system or method.

The terms “an embodiment,” “embodiment,” “embodiments,” “the embodiment,” “the embodiments,” “one or more embodiments,” “some non-limiting embodiments or aspects,” and “one embodiment” mean “one or more (but not all) embodiments of the invention(s),” unless expressly specified otherwise. A description of an embodiment with several components in communication with each other does not imply that all such components are required. On the contrary, a variety of optional components is described to illustrate the wide variety of possible embodiments of the disclosure.

No aspect, component, element, structure, act, step, function, instruction, and/or the like used herein should be construed as critical or essential, unless explicitly described as such. Also, as used herein, the articles “a” and “an” are intended to include one or more items and may be used interchangeably with “one or more” and “at least one.” Where only one item is intended, the term “one” or similar language is used. Also, as used herein, the terms “has,” “have,” “having,” or the like are intended to be open-ended terms. Further, the phrase “based on” is intended to mean “based at least in part on,” unless explicitly stated otherwise. A description of some embodiments or aspects with several components in communication with each other does not imply that all such components are required. On the contrary, a variety of optional components is described to illustrate the wide variety of possible embodiments of the disclosure.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

As discussed herein, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

In the following detailed description of the embodiments of the disclosure, reference is made to the accompanying drawings that form a part hereof, and in which are shown by way of illustration specific embodiments in which the disclosure may be practiced. It should be understood, however, that it is not intended to limit the disclosure to the forms disclosed, but on the contrary, the disclosure is to cover all modifications, equivalents, and alternatives falling within the spirit and the scope of the disclosure. It is to be understood that other embodiments may be utilized and that changes may be made without departing from the scope of the present disclosure. The following description is, therefore, not to be taken in a limiting sense.

Calender systems/multi-rolling mills can be used for processing a film and laminating carrier materials with material processed into film on one or both sides of the carrier material. In some cases, different materials could be laminated on the opposing sides of the carrier, while in other instances a common material is applied to both sides of the carrier. In some instances, it may be desirable to apply materials to one side of the carrier using a different process than the other side. For example, it may be desirable to apply a material to a first side using a different dwell time, pressure, and temperature in a laminating gap to provide a desired heat transfer. Therefore, it may be beneficial to laminate material to one side of the carrier in a different gap from application of material to the other side to allow for customization of dwell time, pressure, and temperature, and other aspects of the film treatment and lamination process.

The present disclosure provides systems and methods for a multi-roll system that allows for lamination of a first material onto a carrier at a first gap nip from a second gap nip where a second material (the same or a different material than the first material) is laminated onto the carrier (a same or different side) to ensure a customizable dwell time, temperature, and pressure and thus, desirable heat transfer to allow proper lamination of a material onto a side of a carrier material. The systems and methods described herein may utilize idle rolls to further allow for longer contact of the foil with the rolls, such that preheating of the foil may not be required. Further, the systems and methods described herein may allow for individual control of temperature and speed of each roll in the system. The systems and methods described herein may also for compression of powder to film and lamination of film to foil be carried out on one machine without the need to rewind and unwind the film multiple times.

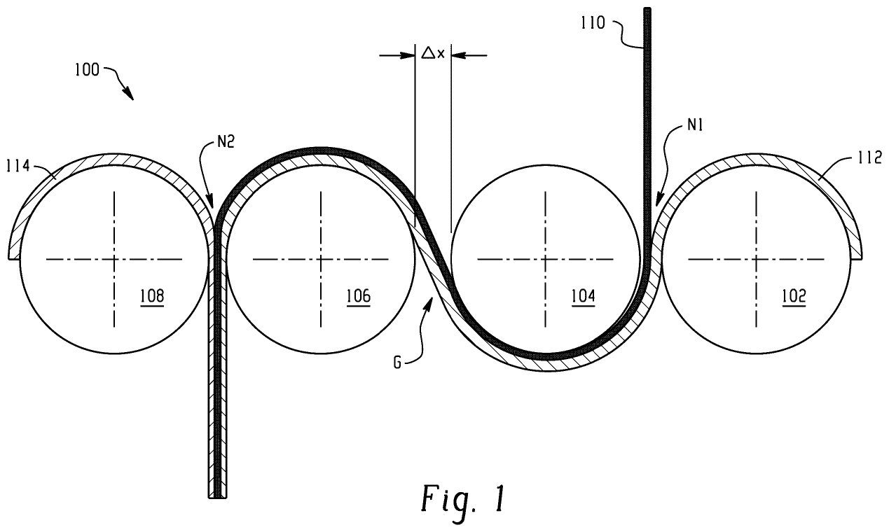

With reference to FIG. 1, a multi-roll calender system 100 is illustrated in accordance with some embodiments of the present disclosure. The multi-roll calender system 100 includes at least four rolls, 102, 104, 106, and 108. The rolls 102, 104, 106, and 108 may be heated. Each roll may be independently controlled, allowing each roll to be heated to a different temperature or the same temperature. Each roll may have the same speed or a different speed. Further, in some embodiments, each roll may have the same diameter. In further embodiments, the rolls 102, 104, 106, and 108 may be horizontally collinear as shown in FIG. 1. In other embodiments, the rolls may be offset from one another. In some embodiments, all the rolls are supported on a common frame structure.

With continued reference to FIG. 1, the first roll 102 and the second roll 104 form a first nip N1. Rolls 102 and 104 receive a foil 110 and a first film 112 and laminate the first film 112 on a first side of the foil 110 in the first nip. The foil 110 may be a carrier material that acts as a current collector. The foil 110 may be made of a metal material, such as copper, aluminum, stainless steel, nickel, or titanium. The foil 110 may be made of carbon-based materials, such as carbon nanofibers, graphite sheets, carbon nanotubes (CNT), or graphene. In some embodiments, the foil 110 may actually be a meshed metal foil, a metal foam, or a carbon coated type current collector. Meshed foil may be lighter than regular foil of the same thickness and provide improved device power density and more active material loading. Foam current collectors have a higher porosity and can improve capacity and thermal management. Carbon coated type current collectors may have improved electrical conductivity and less internal resistance as well as improved adhesion between the foil/film interface. In some embodiments, the foil 110 may have adhesive on one or both sides of the foil 110. In some embodiments, the foil may not be a current collector and may be made of non-metal materials.

The first film 112 may comprise a variety of materials. Example materials include vinyl, plastics, polymers, textiles, rubber, composite materials, paper, or conductive materials. In some embodiments, the first film 112 may comprise an electrode material (the active material), such as anode material or cathode material. The first film 112 may further comprise organic solvents, conducting particles, and binders.

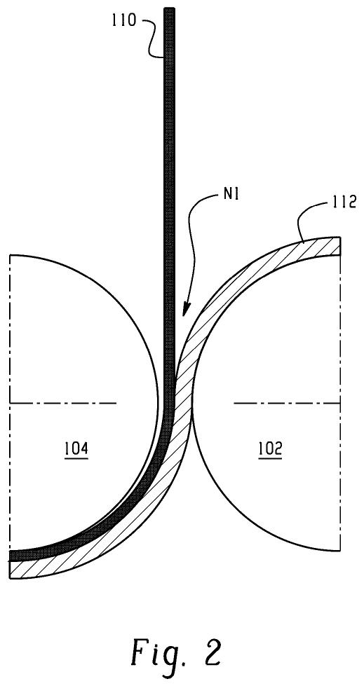

With reference to FIG. 2, which depicts a close up of the first roll 102 and the second roll 104, the foil 110 is received at the first nip N1 formed by the first roll 102 and the second roll 104. The film 112 is laminated onto a side of the foil 110 by the first roll 102 and the second roll 104 at the first nip N1. The lamination of film 112 onto a side of foil 110 occurs by compressing the film 112 and the foil 110 at the first nip N1.

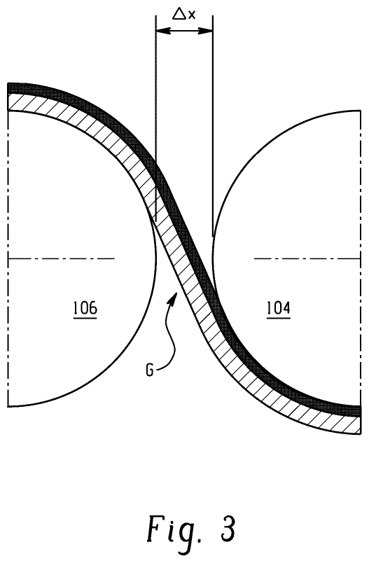

With reference to FIG. 3 and reference back to FIG. 1, the partially laminated foil 110 is received by the second roll 104 and a third roll 106. In this embodiment, the second roll 104 and the third roll 106 form a gap G, as shown in FIG. 3. The gap G measures a distance Δx in length, such that the one-side laminated foil 110 is not touching either roll 104 or roll 106 inside the gap. In some embodiments, the distance Δx may between 0 cm and 30 cm. In other embodiments, the ratio of the distance Δx to the diameter of the second roll or the third roll is between 1:5 and 1:20.

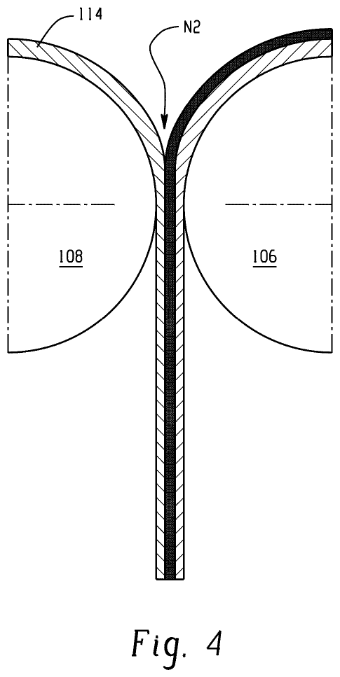

With reference to FIG. 4 and continued reference to FIG. 1, the partially laminated foil 110 is then received by the third roll 106 and a fourth roll 108 at a second nip N2 formed by the third roll 106 and the fourth roll 108. A second film 114 is also received by the third roll 106 and the fourth roll 108 from an opposite direction, as shown in FIG. 4. The second film 114 is laminated onto a second side of the foil 110. The second film 114 may comprise the same or different material than the first film 112. For example, in the case of electrode material, when the foil 110 is a solid current collector (e.g., a foil), the first and second film may be made of different materials. In other situations, the first film and the second film may be made of the same material. For example, when the foil 110 is a metal foam or mesh that is porous, the second film typically comprises the same electrode material as the first film.

The foil 110, laminated on both sides, leaves the calender system 100 from the second nip N2. In some embodiments, the foil 110 may be wound onto a rewinder (not shown). In further embodiments, prior to being wound onto a rewinder, the laminated foil 110 may be cut using a slitter to slit the laminated foil to the preferred width.

The multi-roll calender system 100 allows for each side of the foil to be heated independently. This permits each side of the foil to be heated to a specific temperature for optimal heat transfer between the material and the side of foil the material is being laminated onto. The specific temperature for the side of the foil may vary based on the foil type, adhesive type, material type, and calender speed. Additionally, it allows for the lamination of each side to have the same or different dwell times. In some embodiments, dwell time may refer to the duration the material and foil are subject to pressure and temperature in the nip during lamination. For example, if the first film 112 is an anode material and the second film is a cathode material, in some situations, they may require different dwell times and heating temperatures of the side of the foil that they may be laminated on. Further, the multi-roll calender system 100 allows for the use of different pressure at each lamination nip, so that the desirable pressure may be used to laminate each film onto the foil.

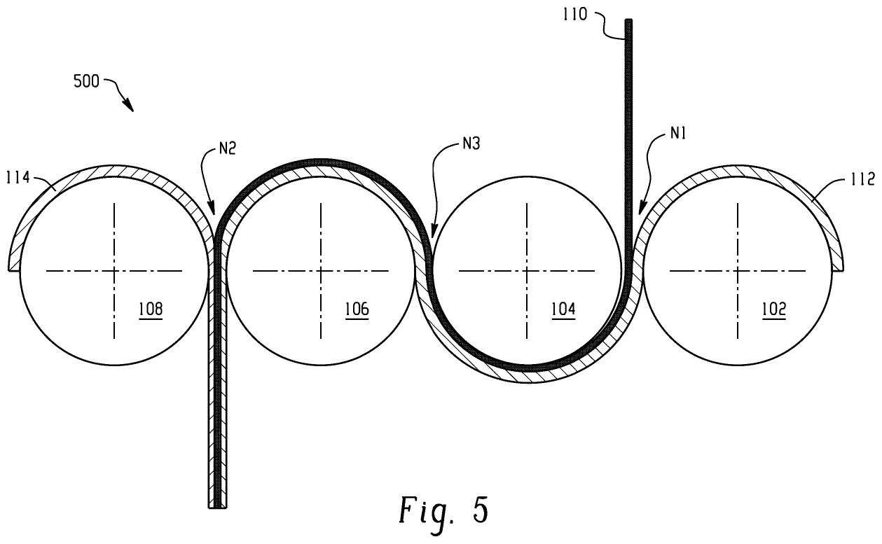

With reference to FIG. 5, the multi-roll calender system 500 depicts an embodiment with four rolls 102, 104, 106, and 108, with no gap G between the second roll 104 and the third roll 106. The first film 112 and the foil 110 is received at the first nip N1 formed by the first roll 102 and the second roll 104. The first film 112 is laminated onto a first side of the foil 110 by the first roll 102 and the second roll 104. The partially laminated foil 110 is received by the second roll 104 and the third roll 106 at a third nip N3 formed by the second roll 104 and the third roll 106. Because the second roll 104 and the third roll 106 form a nip rather than a gap, the partially laminated foil may be compressed further by the second roll 104 and the third roll 106. This additional compression step may have an impact on the thickness of the film 112. The partially laminated foil 110 and the second film 114 is then received by the third roll 106 and the fourth roll 108 at the second nip N2. The third roll 106 and the fourth roll 108 laminate the second film 114 onto a second side of the foil 110. The fully laminated foil 110 then exits the system 500.

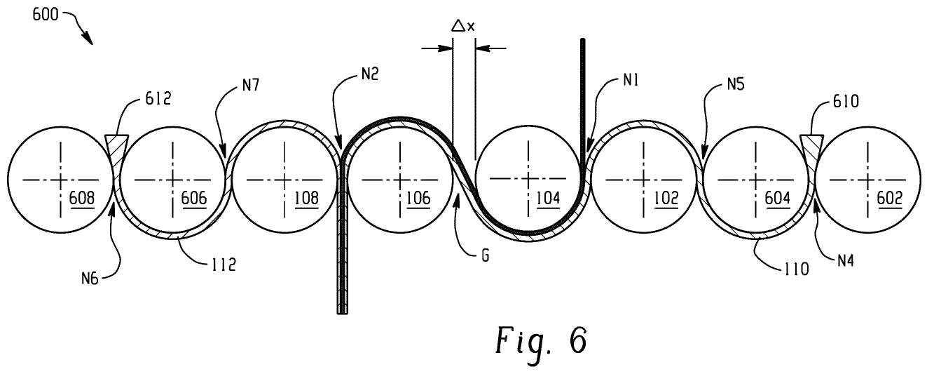

With reference to FIG. 6, the multi-roll calender system 600 depicts an embodiment with eight rolls 102, 104, 106, 108, 602, 604, 606, and 608. The rolls 102, 104, 106, 108, 602, 604, 606, and 608 may be heated. Each roll may be independently controlled, allowing each roll to be heated to a different temperature or the same temperature. Each roll may have the same speed or a different speed. Further, in some embodiments, each roll may have the same diameter. In further embodiments, the rolls 102, 104, 106, 108, 602, 604, 606, and 608 may be horizontally collinear. In other embodiments, the rolls may be offset from one another. In some embodiments, all the rolls are supported on a common frame structure.

The multi-roll calender system 600 includes two material delivery systems 610 and 612. The material delivery systems 610 and 612 may introduce powder material or extruded material to the multi-roll calender system 600. In some embodiments, the material delivery systems may comprise powder hoppers. In other embodiments, the material delivery system may comprise a feeder belt conveyor. In further embodiments, the material delivery system may comprise both a powder hopper and a feeder belt conveyor system. In even further embodiments, the material delivery systems may comprise extruders. As an example, electrode powder may be delivered to the system. The electrode powder may comprise an electrode material (the active material), such as anode material or cathode material. The electrode powder may further comprise organic solvents, conducting particles and binders. In other embodiments, the powder material or extruded material may other materials, such as plastics or composite material.

With continued reference to FIG. 6, on a first end of the system 600, the first material delivery system 610 feeds powder material or extruded material to a first roll 602 and a second roll 604 at a first nip N4 formed by the first roll 602 and the second roll 604. The first roll 602 and the second roll 604 may compress the powder material or extruded material into a first compressed film 110. The compressed film 112 is received by the second roll 604 and a third roll 606 and is further compressed at a second nip N5 formed by the second roll 604 and the third roll 102. On the opposite end of the system 600, the second material delivery system 612 feeds powder material or extruded material to a fourth roll 608 and fifth roll 606 at a third nip N6. The powder or extruded material is fed through the second material delivery system 612 and may comprise the same or different material as the powder fed through the first material delivery system. The fourth roll 608 and the fifth roll 606 compress the powder material or extruded material into a second compressed film 114. The second compressed film 114 is received by the fifth roll 606 and a sixth roll 108 at a fourth nip N7. The fifth roll 606 and the sixth roll 108 compress the film 112 further.

With continued reference to FIG. 6, the third roll 102 and a seventh roll 104 form a fifth nip N1. Rolls 102 and 104 receive a foil 110 and a first compressed film 112 and laminate the first film 112 on a first side of the foil 110 in the fifth nip N1. The partially laminated foil 110 is received by the seventh roll 104 and an eighth roll 106. In this embodiment, the seventh roll 104 and the eighth roll 106 form a gap G. The gap G measures a distance Δx in length, such that the one-side laminated foil 110 is not touching either roll 104 or roll 106 inside the gap. The partially laminated foil 110 is then received by the eighth roll 106 and a sixth roll 108 at a second nip N2 formed by the third roll 106 and the fourth roll 108. A second film 114 is also received by the eighth roll 106 and the sixth roll 108 from an opposite direction. The second film 114 is laminated onto a second side of the foil 110. The fully laminated foil 110 exits the system 600.

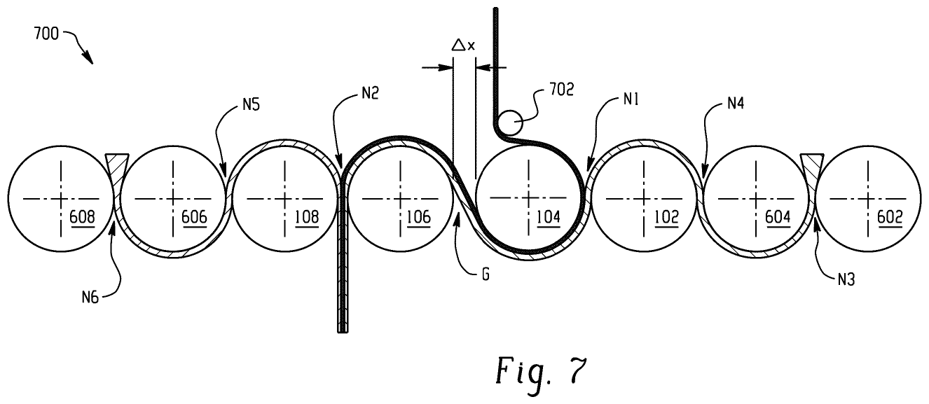

With reference to FIG. 7, another embodiment of a multi-roll calender system 700 includes an idle roll 702. The system 700 includes eight rolls arranged in a similar manner as the multi-roll calender system 600 and compresses and laminates film as described in FIG. 6. The idle roll 702 guides the foil 110 onto the seventh roll 104, such that the foil 110 comes into contact with a larger portion of the seventh roll 104. This allows the foil 110 to be heated on the roll for longer without additional preheating of the foil required.

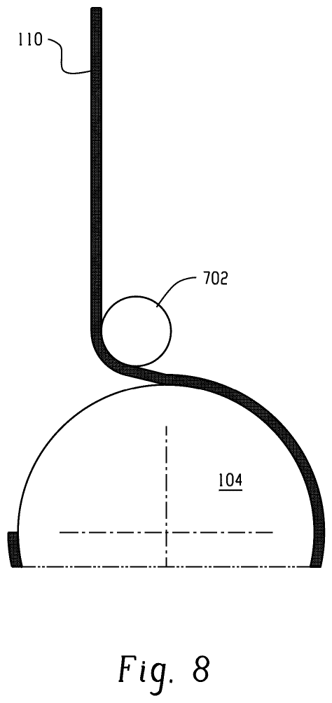

With reference to FIG. 8 and continued reference to FIG. 7, in some embodiments, the idle roll 702 may be smaller in diameter than the seventh roll 104. The idle roll 702 may put more of the circumference of the seventh roll 104 in contact with the foil 110. In further embodiments, the idle roll 702 may be heated. An idle roll may also be incorporated into any of the embodiments described herein. For example, the multi-roll system 100 may include an idle roll to allow for the foil 110 to be in contact with roll 104 for longer.

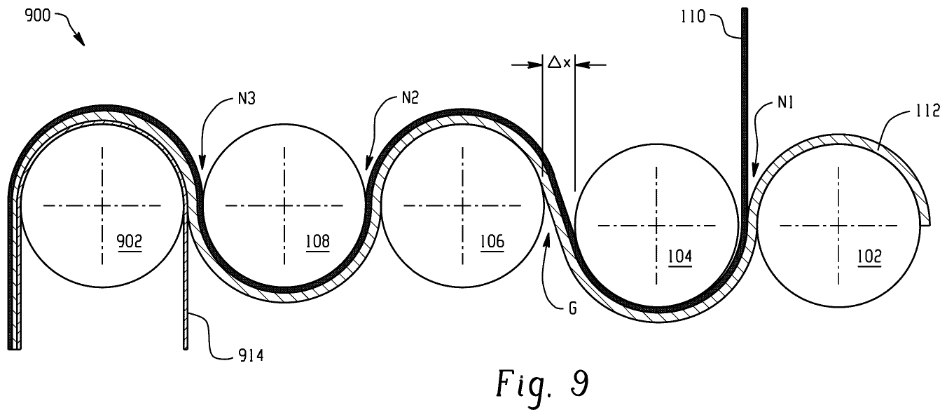

With reference to FIG. 9, a multi-roll calender system 900 may be configured to laminate two layers of film on one side of the foil. The system 900 comprises at least five rolls 102, 104, 106, 108, 902. Additional rolls may be added for various reasons, such as laminating additional film onto the rolls, compressing the film for a desirable thickness, or processing material to create film. All the rolls may have the same diameter or different diameters. Each roll may be individually controlled, allowing each roll to operate at different temperatures and/or speeds.

A first film 112 may be received by the first roll 102 and the second roll 104 at a first nip N1 formed by the first and second rolls 102 and 104. The first film 112 may comprise a variety of materials. Example materials include vinyl, plastics, polymers, textiles, rubber, composite materials, paper, or conductive materials. In some embodiments, the first film 112 may comprise an electrode material (the active material), such as anode material or cathode material. The first film 112 may further comprise organic solvents, conducting particles, and binders. The first roll 102 and the second roll 104 receive a foil 110. The material of the foil may vary based on the films laminated on top of it. For example, if the first film 112 comprises an electrode material, the first film 112 may be a current collector. The first roll 102 and the second roll 104 laminate the first film 112 onto a first side of the foil 110.

With continued reference to FIG. 9, the partially laminated foil 112 is received by the second roll 104 and a third roll 106. The second roll 104 and the third roll may form a gap G with a distance Δx. The distance Δx may be between 0 to 30 cm. Then, the partially laminated foil 112 is received by the third roll 106 and a fourth roll 108 at a second nip N2 formed by the third roll 106 and a fourth roll 108. In some embodiments, the second nip N2 may be a gap with similar characteristics as gap G. Next, the partially laminated foil 112 is received by the fourth roll 108 and a fifth roll 902 at a third nip N3 formed by the fourth roll 108 and the fifth roll 902. The fourth roll 108 and the fifth roll 902 also receive a second film 914 at the third nip and laminate the second film 914 on top on the first film 112 on the same side of the foil. The second film 914 may be the same material or a different material as the first film 112. The partially laminated foil 110 with two layers of films on the same side leaves the third nip N3 and exits the system 900.

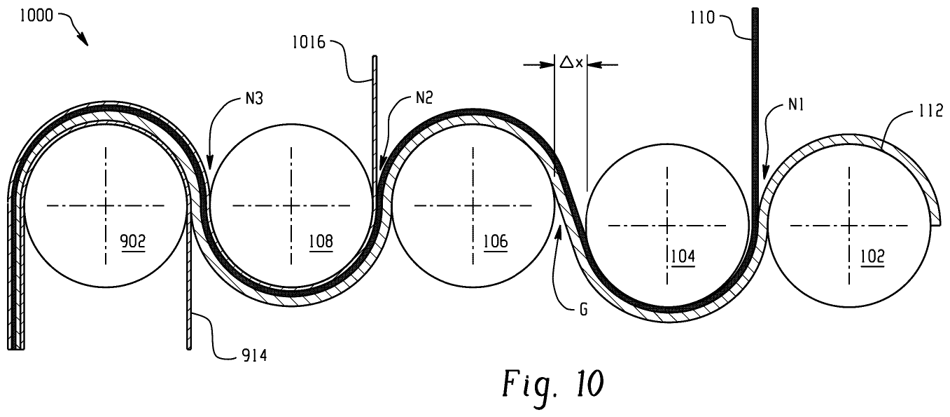

With reference to FIG. 10, multi-roll calender system 1000 depicts lamination of film on both sides of the foil with one side of the foil having two layers of film. The system 1000 has at least five rolls 102, 104, 106, 108, 902. Additional rolls may be added for various reasons, such as laminating additional film onto the rolls, compressing the film for a desirable thickness, or processing material to create film. All the rolls may have the same diameter or different diameters. Each roll may be individually controlled, allowing each roll to operate at different temperatures and/or speeds.

A first film 112 may be received by the first roll 102 and the second roll 104 at a first nip N1 formed by the first and second rolls 102 and 104. The first roll 102 and the second roll 104 laminate the first film 112 onto a first side of the foil 110. The partially laminated foil 112 is received by the second roll 104 and a third roll 106. The second roll 104 and the third roll may form a gap G with a distance Δx. The distance Δx may be between 0 to 30 cm. Then, the partially laminated foil 112 and a second film 1016 are received by the third roll 106 and a fourth roll 108 at a second nip N2 formed by the third roll 106 and a fourth roll 108. The second film 1016 may be the same or different material as the first film 110. The second film 1016 is laminated onto a second side of the foil 110 by the third roll 106 and the fourth roll 108. Next, the laminated foil 112 is received by the fourth roll 108 and a fifth roll 902 at a third nip N3 formed by the fourth roll 108 and the fifth roll 902. The fourth roll 108 and the fifth roll 902 also receive a third film 914 at the third nip and laminate the third film 914 on top on the first film 112 on the same side of the foil. The third film 914 may be the same material or a different material as the first film 112 and/or the second film 1016. The laminated foil 110 leaves the third nip N3 and exits the system 1000.

In some embodiments of multi-roll systems 900 and 1000 may include additional rolls, such that there is a gap between each lamination nip where another layer of film is laminated onto the roll. In other embodiments, more layers of film may be laminated onto one or both sides of the foil 110. In further embodiments, more than one piece of foil may be utilized such that there are multiple layers of foil in the final laminated product that exits the system.

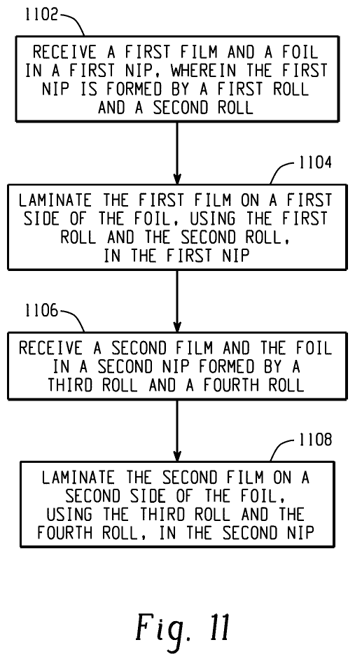

FIG. 11 depicts a flow chart of an example method of laminating material onto a coating carrier using a multi-roll system. The At 1102, a first film and a foil are received in a first nip, wherein the first nip is formed by a first roll and a second roll. At 1104, the first film is laminated on a first side of the foil, using the first roll and the second roll, in the first nip. At 1106, a second film and the foil are received in a second nip formed by a third roll and a fourth roll. At 1108, the second film is laminated on a second side of the foil, using the third roll and the fourth roll, in the second nip.

Although the disclosure has been described in detail for the purpose of illustration based on what are currently considered to be the most practical and preferred embodiments or aspects, it is understood that such detail is solely for that purpose and that the disclosure is not limited to the disclosed embodiments or aspects, but, on the contrary, is intended to cover modifications and equivalent arrangements that are within the spirit and scope of the appended claims. For example, it is understood that the present disclosure contemplates that, to the extent possible, one or more features of any embodiment or aspect can be combined with one or more features of any other embodiment or aspect.

What is claimed:

1. A multi-roll calender, comprising:
a first roll;
a second roll configured to form a first nip in combination with the first roll, wherein the first roll and the second roll laminate a first film on a first side of a foil in the first nip;
a third roll; and
a fourth roll configured to form a second nip in combination with the third roll, wherein the third roll and the fourth roll laminate a second film on a second side of the foil in the second nip.

2. The multi-roll calender of claim 1, wherein the third roll in combination with the second roll is configured to form a gap.

3. The multi-roll calender of claim 2, where the gap is between 0 and 30 cm.

4. The multi-roll calender of claim 1, further comprising:
a fifth roll next to the first roll; and
a sixth roll configured to form a third nip in combination with the fifth roll, wherein the fifth roll and sixth roll are configured to receive powder and form the first film from the powder.

5. The multi-roll calender of claim 1, further comprising:
a seventh roll next to the fourth roll; and
an eighth roll configured to form a fourth nip in combination with the seventh roll, wherein the seventh roll and the eighth roll are configured to receive powder and form the second film from the powder.

6. The multi-roll calender of claim 1, further comprising:
an idle roll configured to allow the film to contact more surface of the second roll.

7. The multi-roll calender of claim 6, wherein the idle roll is smaller in diameter than the second roll.

8. The multi-roll calender of claim 6, wherein the idle roll is heated.

9. The multi-roll calender of claim 1, wherein the first roll, the second roll, the third roll, and the fourth roll have the same diameter.

10. The multi-roll calender of claim 1, wherein all the rolls are horizontally collinear.

11. The multi-roll calender of claim 5, wherein all the rolls are horizontally collinear.

12. The multi-roll calender of claim 1, wherein all the rolls are supported on a common frame structure.

13. The multi-roll calender of claim 6, wherein the first roll is heated.

14. The multi-roll calender of claim 13, wherein the idle roll puts more of the circumference of the heated first roll in contact with the foil.

15. The multi-roll calender of claim 1, wherein the first film and the second film are the same material or different material.

16. The multi-roll calender of claim 1, wherein the first roll and the second roll at the first nip can apply the same pressure or different pressure as the third roll and the fourth roll at the second nip.

17. The multi-roll calender of claim 1, wherein the dwell time for lamination by the first roll and the second roll at the first nip is the same or different than the dwell time for lamination by the third roll and the fourth roll at the second nip.

18. The multi-roll calender of claim 1, wherein each roll can be heated and the temperature of each roll can be independently controlled.

19. A method for laminating film onto both sides of a foil, comprising:
receiving a first film and a foil in a first nip, wherein the first nip is formed by a first roll and a second roll;
laminating the first film on a first side of the foil, using the first roll and the second roll, in the first nip;
receiving a second film and the foil in a second nip formed by the third roll and a fourth roll; and
laminating the second film on a second side of the foil, using the third roll and the fourth roll, in the second nip.
